(19) United States
(12) Patent Application Publication
(10) Pub. No.: US 2010/0071858 A1
(43) Pub. Date: Mar. 25, 2010

(54) Window blind with controlling axle

(76) Inventor: Tony Lai, Rowland Heights, CA (US)

Correspondence Address: DAVID AND RAYMOND PATENT FIRM, 108 N. YNEZ AVE., SUITE 128, MONTEREY PARK, CA, 91754, US

(21) Appl. No.: 12/284,725

(22) Filed: Sep. 23, 2008

(51) Int. Cl. E06B 9/30; E06B 9/34

(52) U.S. Cl. 160/170; 160/168.1 R

(57) ABSTRACT

A window blind includes an operation system, a slat system, and a controlling axle. The operation system includes a plurality of slat cords downwardly supported by a top support. The slat system includes a plurality of slat sets suspendedly supported by the slat cords respectively, wherein each of the slat sets includes a plurality of blind slats horizontally, spacedly and suspendedly supported through the slat cords. The controlling axle is rotatably supported along the top support, wherein the controlling axle includes a controlling shaft and a plurality of controlling units which are coaxially coupled at the controlling shaft and are coupled with the slat cords respectively. When the controlling shaft is driven to rotate, the blind slats are asynchronously and horizontally shifted in responsive to the controlling units so as to selectively adjust a light gap between every two the neighboring blind slats.

### BACKGROUND OF THE PRESENT INVENTION

1. Field of Invention

The present invention relates to the window blinds, and more particularly to a controlling axle of the window blinds, wherein the controlling axle is arranged to control two or more sets of slats in a horizontal displacement in such a manner that when the controlling axle is driven to rotate for asynchronously moving different sets of the slats, the horizontal displacement of one set of the slats is different from that of another set of the slats to selectively adjust a light gap between two neighboring slats.

2. Description of Related Arts

Nowadays, more and more convenient invention for daily life has invented as the developing of tech knowledge, the window blind is one of the convenient daily use and became very popular to people.

As a conventional curtain, people usually hang it out near the windows for reducing the heat from sunlight, and preventing the sunlight pouring inside during day time or observed from other people outside during night time.

The conventional curtain is set up on a curtain stand and operated by a slot of the curtain sliding on a cross axle. In the sliding manner to open and close the curtain is not smooth and inconvenience, so that a slot blind was invented.

As the developing of daily life, there's a window blind with slats in the market and become very popular for human being. The most common window blinds are slat blinds, which consist of a plurality of slats, usually of metal or vinyl, spacedly and parallelly supported by a string in a way that they can be rotated to allow light to pass between the slats. Accordingly, when the slats are rotated at a horizontal orientation, the light can be penetrated through the gap between every two neighboring slats. When the slats are rotated at a vertical orientation, the gap is enclosed by the sequencing slats, so as to block the light penetrating through the window blind. In other words, the light can be controlled to pass through the window blind by selectively adjusting the tilt angles of the slats via the rotational movement of the cross axle.

However, the above slats of the slat windows are series connected to each other by a string and the string coupled with a cross axle to rotate the slats by the string synchronously so as to synchronize the rotational movement of the slats of the window, such that a user cannot adjust the light gaps of the slats as needs. Thus, the slats of the blinds only can work synchronously is one of the main disadvantages of conventional window blinds.

### SUMMARY OF THE PRESENT INVENTION

A main object of the present invention is to provide a window blind, wherein a controlling axle is adapted to control the slats asynchronously such that the horizontal displacement of one set of the slats is different from that of another set of the slats so as to selectively adjust a light gap between two neighboring slats.

Accordingly, in order to accomplish the above object, the present invention provides a window blind which comprises a controlling axle, an operation system, and a slat system. The operation system comprises a plurality of ladder shaped slat cords, wherein each of the slat cords comprises two controlling cords and a plurality of retention cords. The two controlling cords are corresponding to each other and are separated by a horizontal distance. The retention cords are affixedly extended between the two controlling cords and are evenly positioned from top to bottom of the controlling cords. Each of the retention cords comprises two or more crossing strings affixing between the two controlling cords to form a retention cavity between the crossing strings. The slat system is supported by the operation system, wherein the slat system comprises a plurality of slat sets being supported by one of the slat cords. Accordingly, each of the slat sets comprises a plurality of blind slats, wherein each of the blind slats is supported by the corresponding retention cord between the crossing strings.

The controlling axle is rotatably supported along the top support, wherein the controlling axle comprises a controlling shaft and a plurality of controlling units coaxially coupled at the controlling shaft. When the controlling shaft is rotated, the controlling units are driven to be rotated synchronously. Each of the controlling units comprises a plurality of rollers coaxially coupled at the controlling shaft, wherein when the controlling shaft is rotated, the rollers are driven to rotate synchronously. Accordingly, the driven rollers have different circumferential sizes, such that when the controlling shaft is rotated, the rollers are driven to rotate at the same angular displacement and at different arc-length displacement. In other words, the rollers are rotated synchronously while the circumferential surfaces of the rollers are rotated asynchronously. In particularly, the circumferential surface of each of the rollers is a curve surface, preferably is a circular arc surface, such that when the controlling shaft is rotated along a controlling axis, the rollers are synchronously rotated along the controlling axis, so as to stabilize the rotational movement of each of the rollers. As it is mentioned above, the circumferential size of one of the rollers is different from that of another roller such that when the when the controlling shaft is rotated at a rotational angle, the rollers are driven to synchronously rotate at the same rotational angle with respect to the controlling shaft. Due to the difference of the circumferential sizes of the rollers, the arc-length displacements of the rollers are shifted asynchronously. The rollers are large roller and small roller that the circumferential size of the large roller is large than the circumferential size of the small roller. The circumferential sizes of the large and small rollers are configured in responsive to the speed of the horizontal movement of the slat system. Accordingly, each of the rollers has a fixing clipper or a fixing slot provided thereon. It is worth to mention that the slat cords are coupled with the rollers via the fixing clipper or the fixing slot to retain the slat cords in position.

Therefore, the window blind of the present invention enhances the slat operation through the controlling axle. Accordingly, the controlling unit is coupled with the slat system that the slat cord is coupled with the corresponding roller. In other words, when the roller is rotated, the respective slat cord is correspondingly actuated. The slat system is supported by the slat system that the slat set is supported by the corresponding slat cord, wherein each of the blind slats is supported by the corresponding retention cord of the slat cord between the crossing strings thereof. Accordingly, when the rollers are driven to rotate, the slat cords are actuated correspondingly, such that the blind slats are actuated to adjust the horizontal displacements thereof. In other words, the horizontal displacements of the blind slats of the slat set connecting to the large roller are different from the horizontal displacements of the blind slats of the slat set connecting to the small roller, so as to selectively adjust a light gap between every two neighboring blind slats.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a window blind according to a preferred embodiment of the present invention.

FIG. 2 is a perspective view of the operation system of the window blind according to the above preferred embodiment of the present invention.

FIG. 3 is partially perspective view of the operation system according to the above preferred embodiment of the present invention.

FIG. 4 is a partially perspective view of the window blind according to the above preferred embodiment of the present invention.

FIG. 5 is a sectional view of the window blind according to the above preferred embodiment of the present invention, illustrating the structural relationship between the operation system and the slat system.

FIGS. 6A and 6B are schematic views of the window blind according to the above preferred embodiment of the present invention, illustrating different operational positions of the slats.

FIG. 7 is a perspective view of the controlling axle of the window blind according to the above preferred embodiment of the present invention.

FIG. 8 is a schematic view of the window blind according to the above embodiment of the present invention.

FIG. 9 illustrates an alternative mode of the window blind with slats according to the above preferred embodiment of the present invention.

FIG. 10 is a sectional view of the operation system of the alternative window blind according to the above preferred embodiment of the present invention.

### DETAILED DESCRIPTION OF THE PREFERRED EMBODIMENT

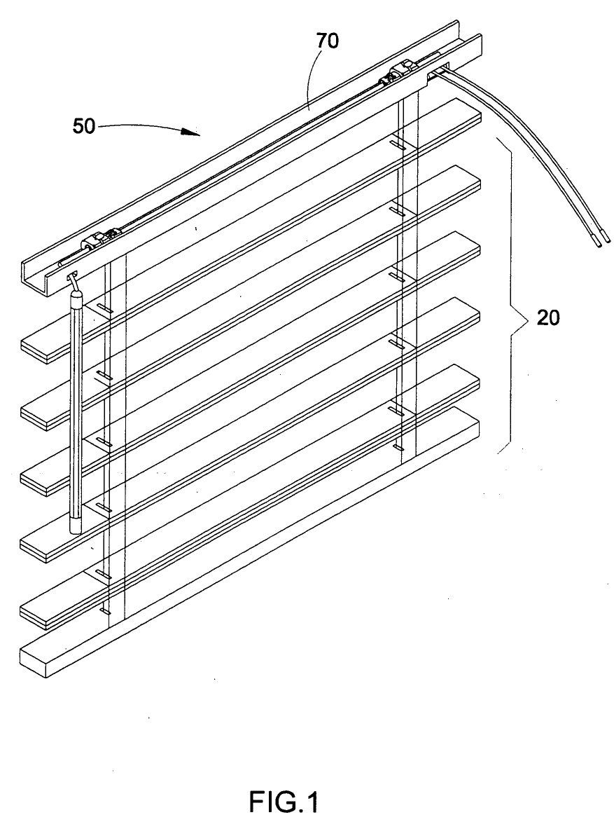

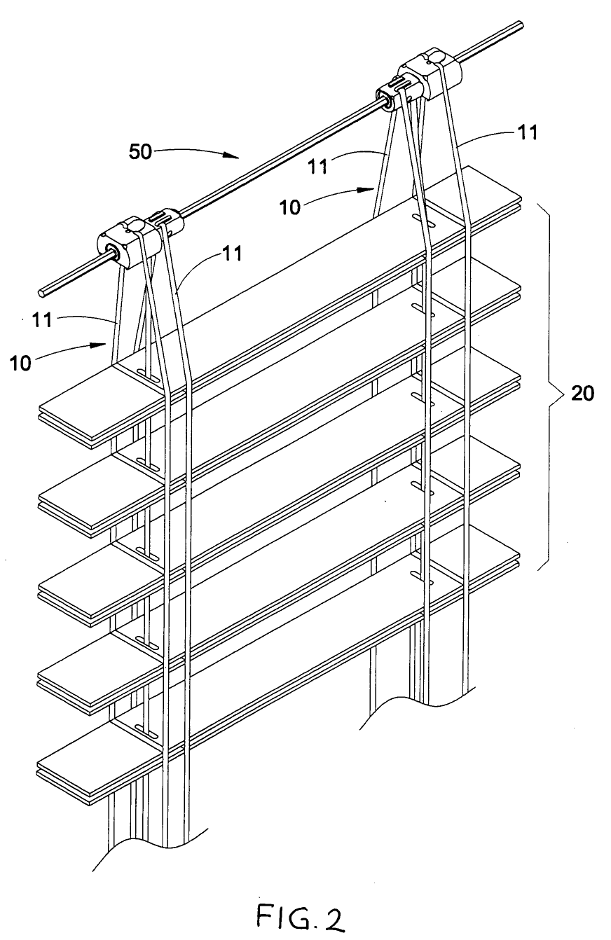

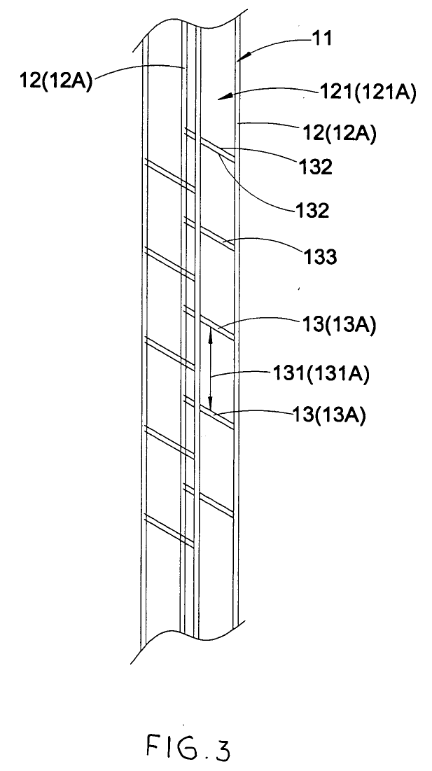

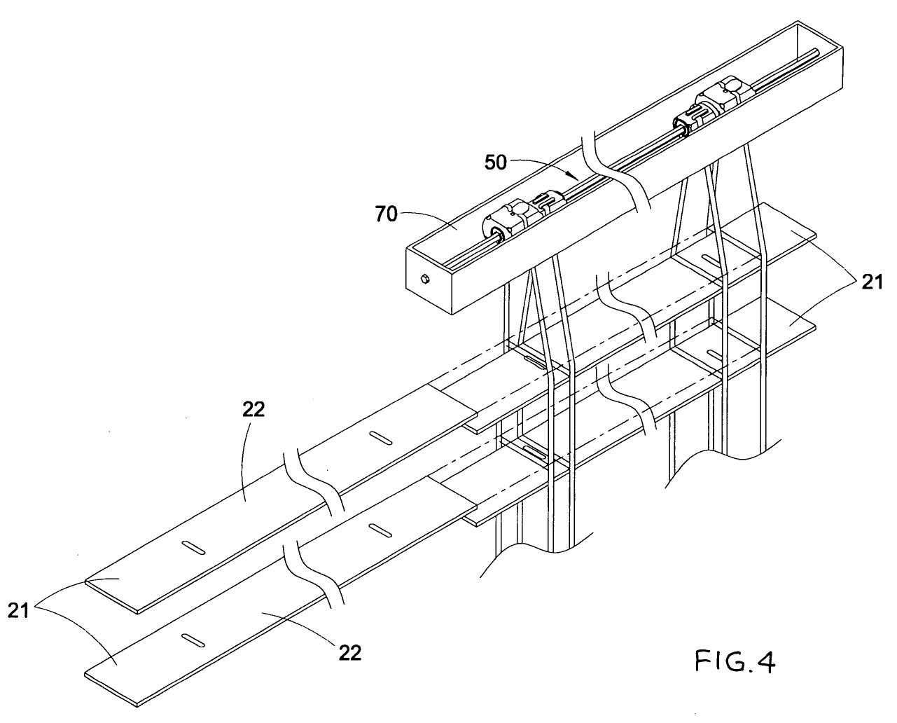

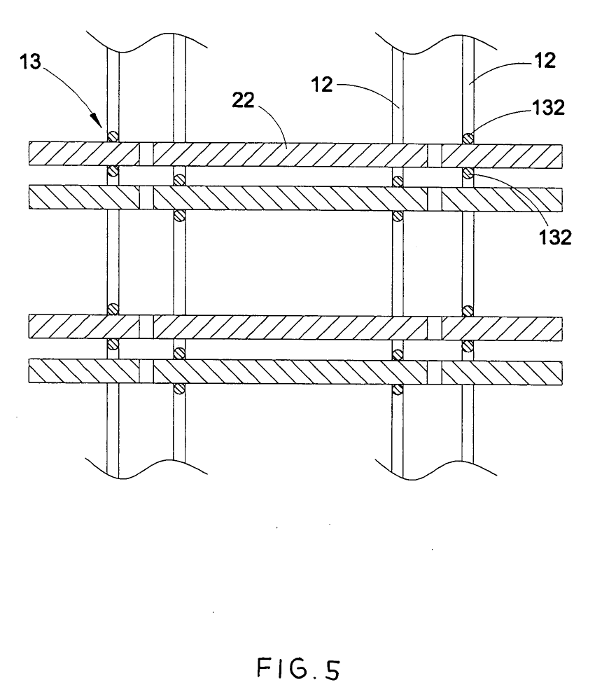

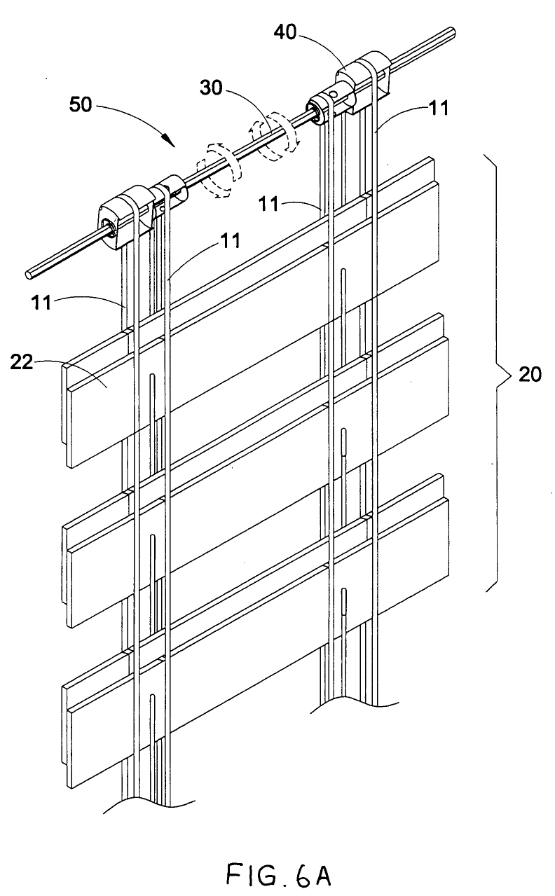

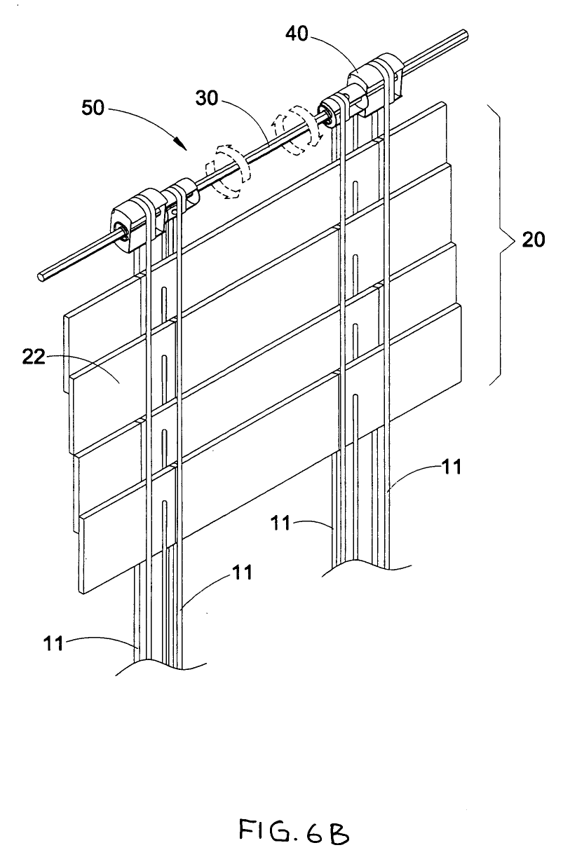

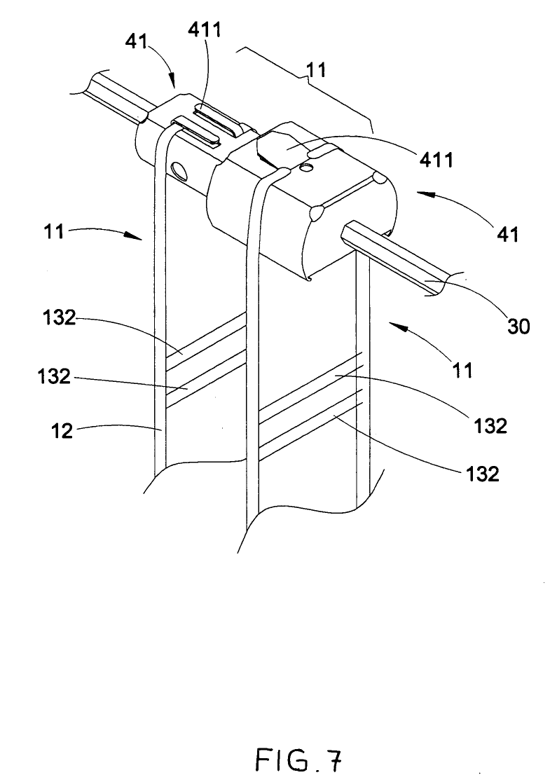

Referring to FIGS. 1 to 7 of the drawings, a window blind according to a preferred embodiment of the present invention is illustrated, wherein the window blind comprises an operation system 10, a slat system 20, and a top support 70.

Accordingly, the operation system 10 comprises a plurality of slat cords 11 downwardly extended from the top support 70, wherein each of the slat cords 11 comprises two controlling cords 12 and a plurality of retention cords 13. The two controlling cords 12 are corresponding to each other and are separated by a horizontal distance 121. The retention cords 13 are affixedly extended between the two controlling cords 12 and are evenly positioned from top to bottom of the controlling cords 12 to define a vertical distance 131 between every two neighboring retention cords 13, such that each of the slat cords 11 forms a ladder structure.

In particularly, each of the retention cords 13 comprises two or more crossing strings 132 affixing between the two controlling cords 12 to form a retention cavity 133 between the crossing strings 132, wherein a vertical distance between two neighboring retention cavities 133 is larger than a distance between two neighboring controlling cords 12.

The slat system 20 is supported by the operation system 10, wherein the slat system 20 comprises a plurality of slat sets 21 being alternatively and suspendedly supported by the slat cords 11. In other words, each of the slat sets 21 is supported by the corresponding slat cords 11. Accordingly, each of the slat sets 21 comprises a plurality of blind slats 22 horizontally and suspendedly supported below the top support 70 at a position between the controlling cords 12, wherein each of the blind slats 22 is supported by the corresponding retention cord 13 between the crossing strings 132. In other words, the blind slats 22 are alternated and supported by the slat sets 21 at the corresponding retention cords 13 thereof.

In addition, the blind slats 22 of each of the slat sets 21 are spacedly and horizontally supported by the corresponding slat cords 11 from top to bottom thereof.

The window blind further comprises a controlling axle 50 rotatably supported along the top support 70, wherein the controlling axle 50 comprises a controlling shaft 30 and a plurality of controlling units 40 coaxially coupled at the controlling shaft 30.

In other words, when the controlling shaft 30 is rotated, the controlling units 40 are driven to be rotated synchronously.

Each of the controlling units 40 comprises a plurality of rollers 41 coaxially coupled at the controlling shaft 30, wherein when the controlling shaft 30 is rotated, the rollers 41 are driven to rotate synchronously. Accordingly, the rollers 41 have different circumferential sizes, such that when the controlling shaft 30 is rotated, the rollers 41 are driven to rotate at the same angular displacement and at different arc-length displacement. In other words, the rollers 41 are rotated synchronously while the circumferential surfaces of the rollers 41 are rotated asynchronously.

In particularly, the circumferential surface of each of the rollers 41 is a curve surface, preferably is a circular arc surface, such that when the controlling shaft 30 is rotated along a controlling axis, the rollers 41 are synchronously rotated along the controlling axis, so as to stabilize the rotational movement of each of the rollers 41.

As it is mentioned above, the circumferential size of one of the rollers 41 is different from that of another roller 41 such that when the when the controlling shaft 30 is rotated at a rotational angle, the rollers 41 are driven to synchronously rotate at the same rotational angle with respect to the controlling shaft 30. Due to the difference of the circumferential sizes of the rollers 41, the arc-length displacements of the rollers 41 are shifted asynchronously. In other words, the points at the circumferential surfaces of the large and small rollers 41 are asynchronously shifted at different speeds thereof.

Accordingly, the rollers 41 are large roller and small roller that the circumferential size of the large roller is larger than the circumferential size of the small roller. In particularly, the diameter of the large roller is larger than the diameter of the small roller. The circumferential sizes of the large and small rollers are configured in responsive to the speed of the horizontal movement of the slat system 10.

Accordingly, each of the rollers 41 has a fixing clipper 411 provided on the circumferential surface thereof.

The controlling unit 40 is coupled with the slat system 10 that the slat cord 11 is coupled with the corresponding roller 41. In other words, when the roller 41 is rotated, the respective slat cord 11 is correspondingly actuated.

The slat system 20 is supported by the slat system 10 that the slat set 21 is supported by the corresponding slat cord 11, wherein each of the blind slats 22 is supported by the corresponding retention cord 13 of the slat cord 11 between the crossing strings 132 thereof.

Accordingly, when the rollers 41 are driven to rotate, the slat cords 11 are actuated correspondingly, such that the blind slats 22 are actuated to adjust the horizontal positions thereof. In other words, the horizontal displacements of the blind slats 22 of the slat set 21 connecting to the large roller 41 are different from the horizontal displacements of the blind slats 22 of the slat set 21 connecting to the small roller 41, so as to selectively adjust the light gap between every two neighboring blind slats 22.

It is worth to mention that the slat cords 11 are securely coupled with the rollers 41 via the fixing clipper 411 to retain the slat cords 11 in position when the rollers 41 are driven to rotate via the rotational movement of the controlling shaft 30.

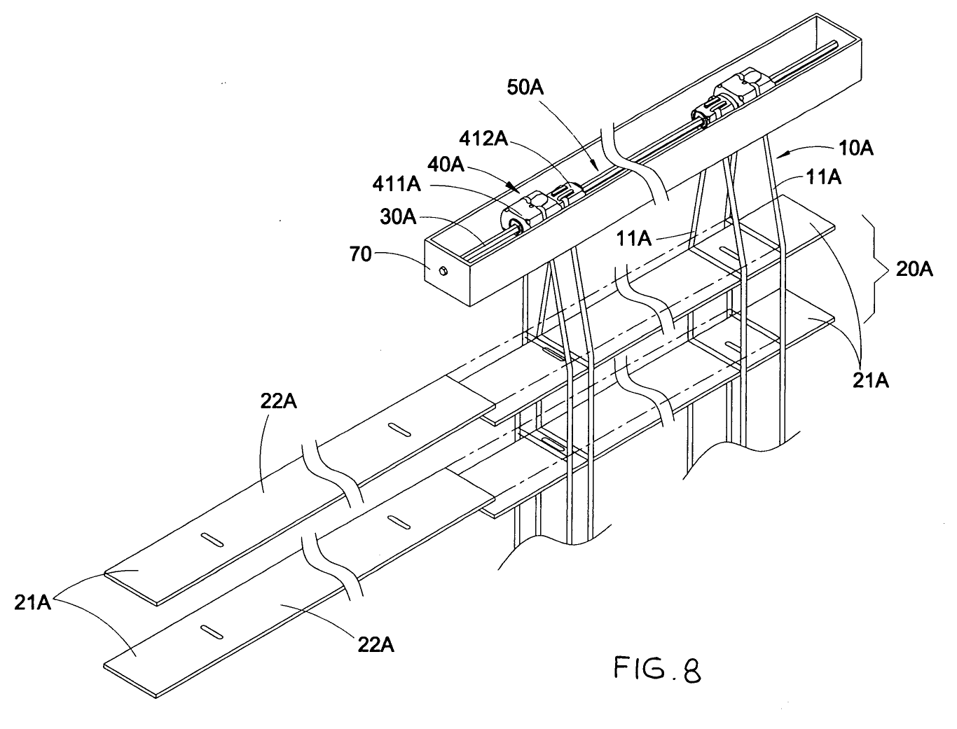

FIGS. 1 to 8 also illustrate an alternative mode of the window blind of the present invention, wherein the controlling axle 50A is rotatably supported within the top support 70. The controlling axle 50A comprises a controlling shaft 30A and a plurality of controlling units 40A coaxially coupled at the controlling shaft 30A.

Each of the controlling units 40A comprises a large roller 411A and a small roller 412A, wherein a diameter of the large roller 411A is larger than a diameter of the small roller 412A.

The window blind of the present invention further comprises an operation system 10A and a slat system 20A.

Accordingly, the operation system 10A comprises a plurality of slat cords 11A, wherein each of the slat cords 11A comprises two controlling cords 12A and a plurality of retention cords 13A. The two controlling cords 12A are corresponding to each other and are separated by a horizontal distance 121A. The retention cords 13A are affixedly extended between the two controlling cords 12A and are evenly positioned from top to bottom of the controlling cords 12A to define a vertical distance 131A between every two neighboring retention cords 13A, such that each of the slat cords 11A forms a ladder structure.

The slat system 20A is supported by the operation system 10A, wherein the slat system 20A comprises a plurality of slat sets 21A being alternated and supported by one of the slat cords 11A. In other words, each of the slat sets 21A is supported by the corresponding slat cords 11A. Accordingly, each of the slat sets 21A comprises a plurality of blind slats 22A, wherein each of the blind slats 22A is supported by the corresponding retention cord 13A.

In addition, the blind slats 22A of each of the slat sets 21A are spacedly and horizontally supported by the corresponding slat cords 11A from top to bottom thereof.

The upper portion of each of the slat cords 11A of the operation system 10A is affixed to the corresponding controlling unit 40A of the controlling axle 50A.

Accordingly, when the controlling shaft 30A of the controlling axle 50A is driven to rotate, the controlling units 40A are rotated synchronously. Since the large roller 411A has a larger diameter in comparison with the small roller 412A, the upward lifting movement of the slat cord 11A coupling with the large roller 411A is faster than the upward lifting movement of the slat cord 11A coupling with the small roller 412A.

Simultaneously, the upward lifting movements of the slats 22A of the slat set 21A linked to the large roller 411A through the corresponding slat cord 11A are faster than the upward lifting movements of the slats 22A of the slat set 21A linked to the small roller 412A through the corresponding slat cord 11A.

Therefore, the differential displacement is provided between the slats 22A of the different slat sets 21A through the large and small rollers 411A, 412A. In other words, the blind slats 22A linked to the large roller 411A are shifted at the horizontal displacement larger than the horizontal displacement of the blind slats 22A linked to the small roller. Therefore, the light gap between two neighboring slats 22A of the slat sets 21A can be selectively adjusted by the rotational movement of the controlling axle 50A.

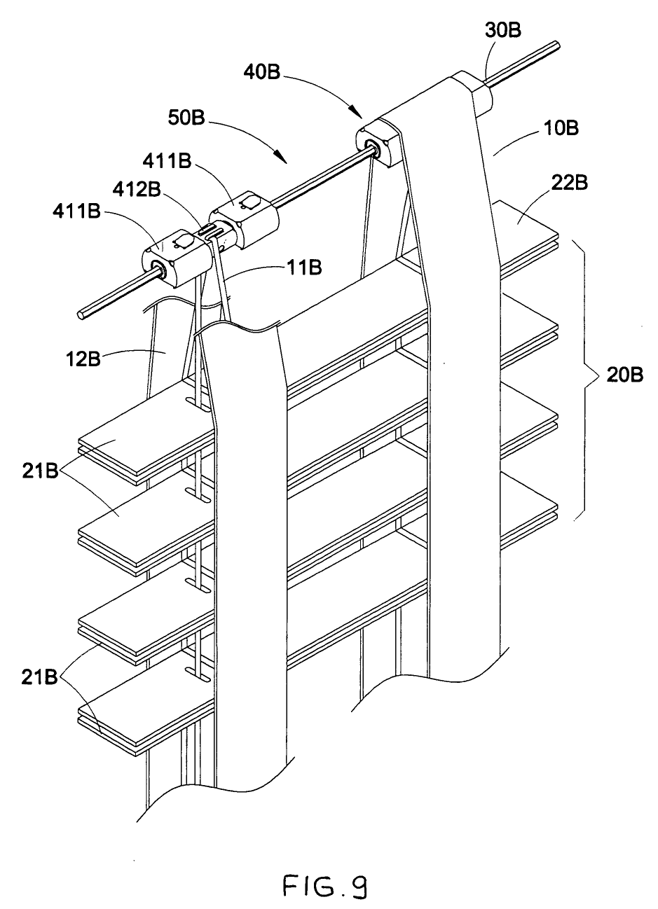

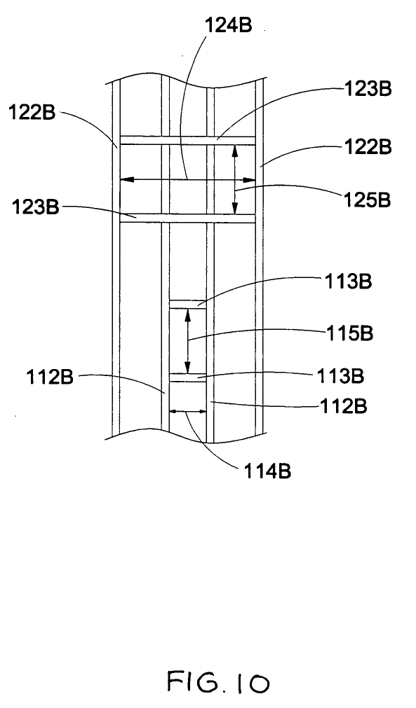

FIGS. 9 and 10 further illustrate another alternative mode of the window blind, wherein the controlling axle 50B is rotatably supported within the top support 70. The controlling axle 50B comprises a controlling shaft 30B and a plurality of controlling units 40B coaxially coupled at the controlling shaft 30B.

Each of the controlling units 40B comprises a plurality of large rollers 411 B and a plurality of small rollers 412B, wherein a diameter of the large roller 411B is larger than a diameter of the small roller 412B.

In particularly, the small roller 412B is coaxially coupled at the controlling shaft 30B between the two large rollers 411B.

The window blind of the present invention further comprises an operation system 10B and a slat system 20B.

The slat system 20B comprises a plurality of slat cords 11B and a plurality of slat bands 12B, wherein the number of the slat cords 11B is the same as the number of the slat bands 12B.

Each of the slat cords 11B comprises two controlling cords 112B and plurality of retention cords 113B. The two controlling cords 112B are corresponding to each other and are separated by a horizontal distance 114B. The retention cords 113B are affixedly extended between the two controlling cords 112B and are evenly positioned from top to bottom of the controlling cords 112B to define a vertical distance 115B between every two neighboring retention cords 113B, such that each of the slat cords 11B forms a ladder structure.

In addition, each of the slat bands 12B comprises two controlling bands 122B and a plurality of retention bands 123B, wherein the two controlling bands 122B are corresponding to each other and are separated by a horizontal distance 124B. The retention bands 123B are affixedly extended between the two controlling bands 122B and are evenly positioned from top to bottom of the controlling bands 122B to define a vertical distance 125B between every two neighboring retention bands 123B, such that each of the slat bands 12B also forms a ladder structure.

The slat system 20B is supported by the operation system 10B, wherein the slat system 20B comprises a plurality of slat sets 21B being alternated and supported by the slat cords 11B and the slat bands 12B respectively. In other words, each of the slat sets 21B is supported by the corresponding slat cords 11B or the corresponding slat bands 12B. Accordingly, each of the slat sets 21B comprises a plurality of blind slats 22B, wherein each of the blind slats 22B is supported by the corresponding retention cord 113B or the corresponding retention band 123B.

In addition, the blind slats 22B of each of the slat sets 21B are spacedly and horizontally supported by the corresponding slat cords 11B or the corresponding slat bands 12B from top to bottom thereof.

The upper portion of each of the slat cords 11B and the slat bands 12B of the operation system 10B is affixed to the corresponding controlling unit 40B of the controlling axle 50B.

Accordingly, the slat cords 11B are paired with the slat bands 12B respectively to form a plurality of operation sets that each of the operation sets comprises one slat cord 11B and one slat band 12B. In addition, the slat band 12B of each of the operation sets is coupled with the large roller 411B while the slat cord 11B of each of the operation sets is coupled with the small roller 412B.

Accordingly, when the controlling shaft 30B of the controlling axle 50B is driven to rotate, the controlling units 40B are rotated synchronously. Since the large roller 411B has a larger diameter in comparison with the small roller 412B, the upward lifting movement of the slat band 12B coupling with the large roller 411B is faster than the upward lifting movement of the slat cord 11B coupling with the small roller 412B.

Simultaneously, the upward lifting movements of the slats 22B of the slat set 21B linked to the large roller 411B through the corresponding slat band 11B are faster than the upward lifting movements of the slats 22B of the slat set 21B linked to the small roller 412B through the corresponding slat cord 11B.

Therefore, the differential displacement is provided between the slats 22B of the different slat sets 21B through the large and small rollers 411B, 412B. In other words, the light gap between two neighboring slats 22B of the slat sets 21B can be selectively adjusted by the rotational movement of the controlling axle 50B.

Therefore, the controlling shaft 30 (30A, 30B) of the above embodiments of the present invention can be driven to rotate by manual, electrical motor, or any other mechanical ways, so that the controlling shaft 30 (30A, 30B) can control the controlling units 40 (40A, 40B) to rotate synchronously, so as to selectively control the horizontal displacements of blind slats 22 (22A, 22B) via the rollers 40 (40A, 40B).

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A window blind, comprising:
a top support;
an operation system which comprises a plurality of slat cords downwardly supported by said top support;
a slat system which comprises a plurality of slat sets suspendedly supported by said slat cords respectively, wherein each of said slat sets comprises a plurality of blind slats horizontally, spacedly and suspendedly supported below said top support through said slat cords; and
a controlling axle rotatably supported along said top support, wherein said controlling axle comprises a controlling shaft and a plurality of controlling units which are coaxially coupled at said controlling shaft and are coupled with said slat cords respectively, such that when said controlling shaft is driven to rotate, said blind slats are asynchronously and horizontally shifted in responsive to said controlling units so as to selectively adjust a light gap between every two said neighboring blind slats.

2. The window blind, as recited in claim 1, wherein said controlling units comprises a large roller and a small roller which are coaxially coupled at said controlling shaft, wherein a circumferential size of said large roller is larger than a circumferential size of said small roller, wherein said slat cords are coupled with said large and small rollers respectively, such that when said controlling shaft is driven to rotate at a rotational angle, said large and small rollers are synchronously rotated at said rotational angle and are asynchronously rotated at different arc-length displacement.

3. The window blind, as recited in claim 2, wherein a diameter of said large roller is larger than a diameter of said small roller such that said large and small rollers are synchronously rotated in responsive to said controlling shaft and are asynchronously shifted in responsive to circumferential surfaces of said rollers.

4. The window blind, as recited in claim 2, wherein each of said large and small rollers comprises a fixing clipper securely coupled with an upper portion of said respective slat cord to retain said slat cord in position when said large and small rollers are driven to rotate via said controlling shaft.

5. The window blind, as recited in claim 3, wherein each of said large and small rollers comprises a fixing clipper securely coupled with an upper portion of said respective slat cord to retain said slat cord in position when said large and small rollers are driven to rotate via said controlling shaft.

6. The window blind, as recited in claim 1, wherein said slat sets are alternated and supported by said slat cords respectively.

7. The window blind, as recited in claim 3, wherein said slat sets are alternated and supported by said slat cords respectively.

8. The window blind, as recited in claim 5, wherein said slat sets are alternated and supported by said slat cords respectively.

9. The window blind, as recited in claim 1, wherein each of said slat cords, having a ladder structure, comprises two controlling cords retaining said blind slats therebetween, and a plurality of retention cords evenly extended between said controlling cords to support said blind slats respectively.

10. The window blind, as recited in claim 5, wherein each of said slat cords, having a ladder structure, comprises two controlling cords retaining said blind slats therebetween, and a plurality of retention cords evenly extended between said controlling cords to support said blind slats respectively.

11. The window blind, as recited in claim 8, wherein each of said slat cords, having a ladder structure, comprises two controlling cords retaining said blind slats therebetween, and a plurality of retention cords evenly extended between said controlling cords to support said blind slats respectively.

12. The window blind, as recited in claim 9, wherein each of said retention cords comprises two crossing strings affixing between said two controlling cords to form a retention cavity between said crossing strings for receiving said respective blind slat at said retention cavity.

13. The window blind, as recited in claim 10, wherein each of said retention cords comprises two crossing strings affixing between said two controlling cords to form a retention cavity between said crossing strings for receiving said respective blind slat at said retention cavity.

14. The window blind, as recited in claim 11, wherein each of said retention cords comprises two crossing strings affixing between said two controlling cords to form a retention cavity between said crossing strings for receiving said respective blind slat at said retention cavity.

15. The window blind, as recited in claim 1, wherein said operation system further comprises a plurality of slat bands downwardly supported by said top support, wherein said blind slats are alternated supported by said slat cords and said slat bands respectively, wherein slat cords and said slat bands are coupled with said controlling units respectively.

16. The window blind, as recited in claim 15, wherein each of said controlling units comprises two large rollers and a small roller which are coaxially coupled at said controlling shaft, wherein a circumferential size of said large roller is larger than a circumferential size of said small roller, wherein said small roller is positioned between said two large rollers, wherein upper portions of said slat bands and said slat cords are coupled with said large and small rollers respectively, such that when said controlling shaft is driven to rotate at a rotational angle, said large and small rollers are synchronously rotated at said rotational angle and are asynchronously rotated at different arc-length displacement.

17. The window blind, as recited in claim 16, wherein a diameter of said large roller is larger than a diameter of said small roller such that said large and small rollers are synchronously rotated in responsive to said controlling shaft and are asynchronously shifted in responsive to circumferential surfaces of said rollers.

18. The window blind, as recited in claim 17, wherein each of said slat cords, having a ladder structure, comprises two controlling cords retaining said blind slats therebetween, and a plurality of retention cords evenly extended between said controlling cords to support said blind slats respectively, wherein each of said retention cords comprises two crossing strings affixing between said two controlling cords to form a retention cavity between said crossing strings for receiving said respective blind slat at said retention cavity.

19. The window blind, as recited in claim 18, wherein each of said slat bands, also having a ladder structure, comprises two controlling bands retaining said blind slats therebetween, and a plurality of retention bands evenly extended between said controlling bands to support said blind slats respectively.

20. The window blind, as recited in claim 19, wherein said slat cords are paired with said slat bands respectively to form a plurality of operation sets that said blind slats are alternatively supported by each of said operation sets.
